(19) United States
(12) Patent Application Publication
(10) Pub. No.: US 2019/0186836 A1
(43) Pub. Date: Jun. 20, 2019

(54) CONDITIONING APPARATUS AND METHOD FOR CONDITIONING A GASEOUS MEDIUM, AND INSTALLATION AND METHOD FOR TREATING WORKPIECES

(71) Applicant: EISENMANN SE, Böblingen (DE)

(72) Inventors: Mathias MOLL, Weil im Schönbuch (DE); Harald SONNER, Sindelfingen (DE)

(21) Appl. No.: 16/322,749

(22) PCT Filed: Aug. 3, 2017
(86) PCT No.: PCT/EP2017/069735

§ 371 Date: Feb. 1, 2019

(30) Foreign Application Priority Data
Aug. 4, 2016 (DE) 10 2016 114 466.5

(51) Int. Cl. F28D 1/047; B05B 16/60

(52) U.S. Cl. CPC F28D 1/0477; F28F 19/00; B05B 16/60

(57) ABSTRACT

A conditioning apparatus for conditioning a gaseous medium to form a conditioned gaseous process medium having an inlet connection unit and an outlet connection unit, between which there is formed a flow path for gaseous medium having one or more conditioning stages, of which at least one has a heat exchanger. The heat exchanger has a heat exchanger chamber in which a heat exchanger element is at least partially accommodated and to which gaseous medium for conditioning can be supplied, wherein, in the heat exchanger, there are sensitive material regions which can be damaged by the gaseous medium. A heat exchanger protection system is provided by means of which such sensitive regions of the heat exchanger can be impinged on with a protective gas. Also specified are a method for conditioning a gaseous medium, and an installation and a method for treating workpieces.

The invention relates to a conditioning apparatus for conditioning a gaseous medium to yield a conditioned gaseous process medium, having
a) an inlet connection unit and an outlet connection unit, between which is formed a flow path for gaseous medium having one or more conditioning stages, at least one of which comprises a heat exchanger;
b) the heat exchanger has a heat exchange chamber, in which a heat exchange element is accommodated at least in part and to which gaseous medium to be conditioned may be supplied, the heat exchanger comprising regions of sensitive material which may be damaged by the gaseous medium.

The invention further relates to a method for conditioning a gaseous medium and to an installation and a method for treating workpieces.

Conditioning apparatuses of the above-mentioned type are used for example in the automotive industry in installations for treating vehicle bodies and in this case in particular in treatment booths in which coated vehicle bodies are treated in the context of a painting process. These include in particular paint booths, and also for example evaporation booths, cooling booths and dryers, in each case having a treatment tunnel.

The tunnel air is circulated in such treatment booths and to this end is removed from the treatment tunnel as a gaseous medium to be conditioned and, after conditioning in a conditioning apparatus, resupplied to the treatment tunnel as conditioned process medium. However, the tunnel air contains aggressive constituents, which are released during treatment of the vehicle bodies. In a conditioning apparatus, the removed tunnel air passes through different conditioning stages, in which, among other things, aggressive constituents are removed and the humidity and temperature of the tunnel air are adjusted. The latter proceeds via heat exchangers.

However, heat exchangers have sensitive regions which may be damaged by the aggressive constituents of the tunnel air before they are removed from the tunnel air. Such sensitive regions are present in particular at heat exchanger tube connection points, which are generally soldered or brazed.

Components which are attacked by the aggressive constituents of the tunnel air therefore have frequently to be replaced after only a short service period, which drives up costs.

It is an object of the invention to provide a conditioning apparatus and a method for conditioning a gaseous medium and an installation and a method for treating workpieces which take account of these issues.

This object is achieved for a conditioning apparatus of the above-mentioned type in that
c) a heat exchanger protection system is provided by means of which such sensitive regions of the heat exchanger may be exposed to a protective gas.

The invention is based on the recognition that effective protection of such sensitive regions of a heat exchanger may thereby be achieved. In principle, the protective gas may be any gas which is economically feasible and does not have any undesired properties. For example, compressed air from external sources, or indeed inert gases such as nitrogen or carbon dioxide may be used. Good use is made of the resources available if gas from the conditioning apparatus is used; this will be addressed in greater detail below.

In the simplest variant, the protective gas could be blown directly onto sensitive regions of the heat exchanger for example via one or more nozzles. It is however more effective for the heat exchanger protection system to comprise at least one protective housing, which surrounds one or more sensitive regions of the heat exchanger and to which protective gas may be supplied via a protective gas line.

It is particularly resource-efficient for the protective gas line to be connected to the flow path or downstream of the final conditioning stage in such a way that partly conditioned gas or process medium from the conditioning apparatus and serving as protective gas may be conveyed into the protective housing.

Advantageously, the protective housing comprises at least one protective gas outlet through which protective gas may flow, after flowing through the protective housing, into the heat exchange chamber. In this way, the protective gas is, as it were, circulated in the conditioning apparatus and may in this way once again contribute to the conditioned process medium.

In order to be able to adjust the volumetric flow rate of the protective gas, it is favorable for a protective gas blower and/or an adjusting valve to be arranged in the protective gas line.

Such a heat exchanger protection system may be used particularly effectively if sensitive regions of the heat exchanger are formed by tube connection points at which tubes or tube sections of the heat exchanger are joined fluid-tightly together.

The exposure to protective gas is particularly effective if tubes or tube sections of the heat exchanger are welded together or soldered or brazed together at tube connection points. Joining may also proceed by adhesive bonding or the like. Such connection points may be effectively protected.

If a plurality of conditioning stages are present which comprise a heat exchanger, it is favorable for these heat exchangers to be integrated into the heat exchanger protection system.

The above-stated object is achieved in a method for conditioning a gaseous medium in that a conditioning apparatus having some or all of the explained features is used.

In an installation for treating workpieces, the above-stated object is achieved in that it comprises a conditioning apparatus having some or all of the explained features.

In a method for treating workpieces, the above-stated object is achieved in that the workpieces are treated in an installation having some or all of the features explained above in relation to the installation.

Exemplary embodiments of the invention are explained in greater detail below with reference to the drawings, in which:

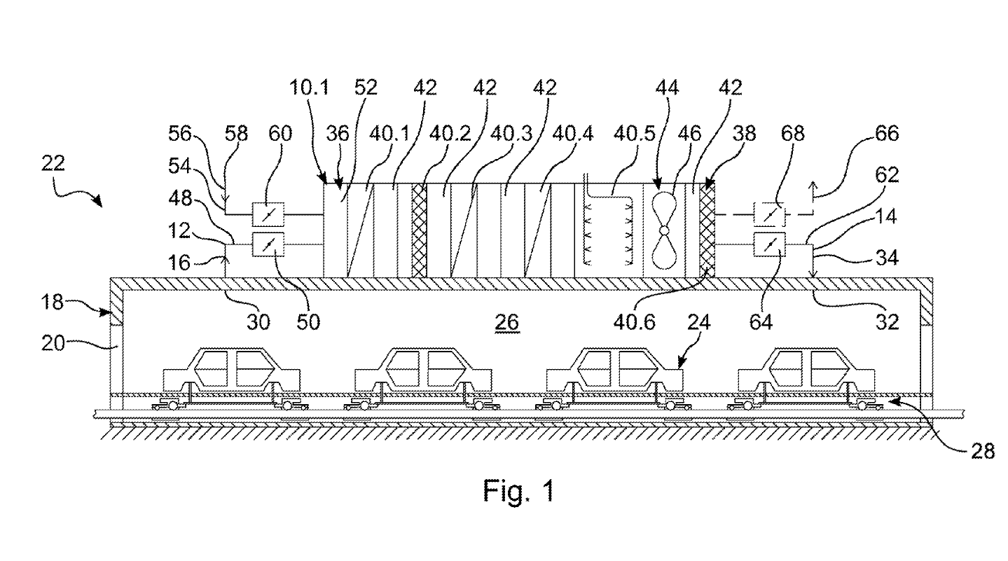

FIG. 1 shows a longitudinal section through a treatment means for treating vehicle bodies having a treatment tunnel, to which conditioned process air, which has been conditioned by means of a conditioning apparatus, is supplied by means of an air supply device, wherein the conditioning apparatus comprises at least one heat exchanger having a heat exchange coil;

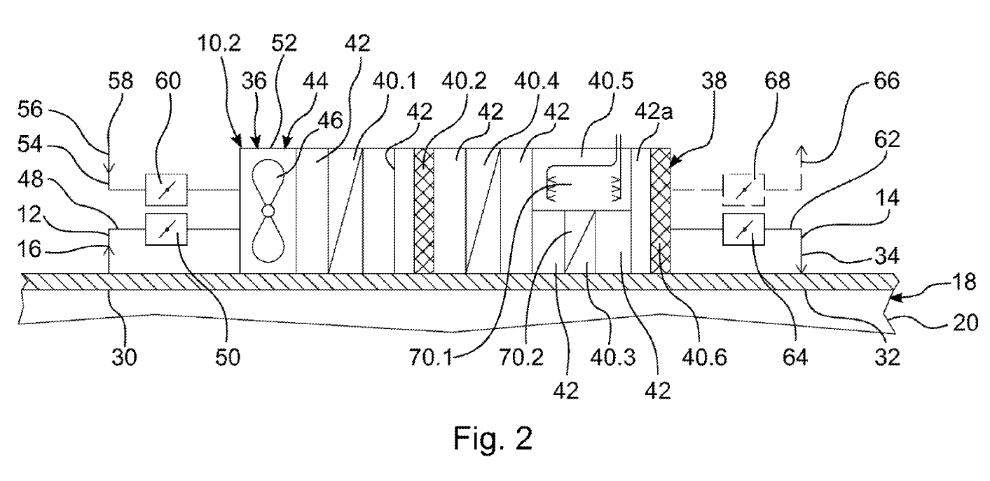

FIG. 2 shows a longitudinal section through a modified conditioning apparatus;

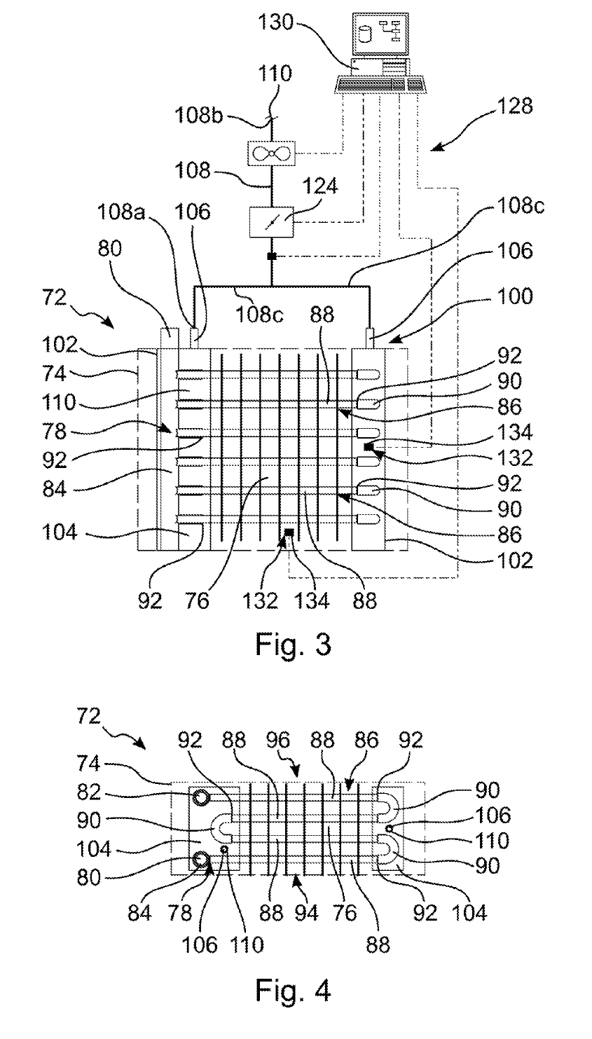

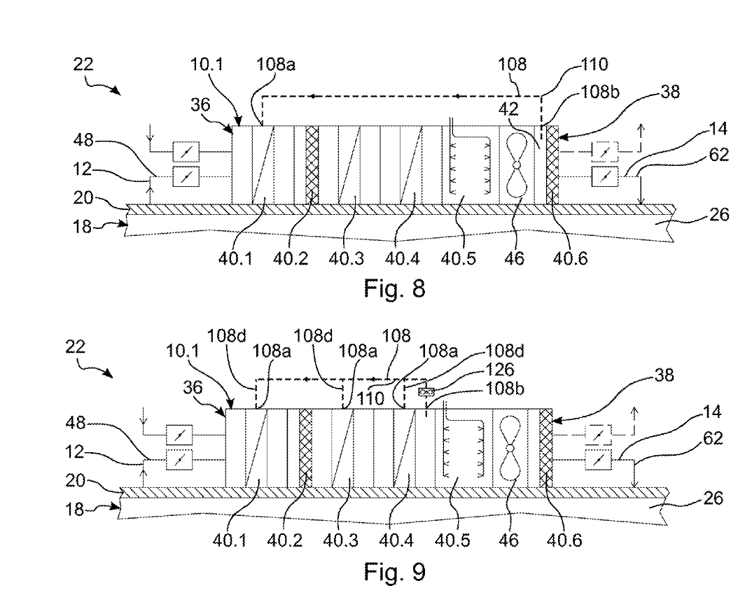

FIG. 3 is a detail view of part of a heat exchanger protection system according to FIGS. 8 to 11, taking a heat exchanger as example, wherein a control device is additionally shown;

FIG. 4 shows the heat exchanger according to FIG. 3 in plan view;

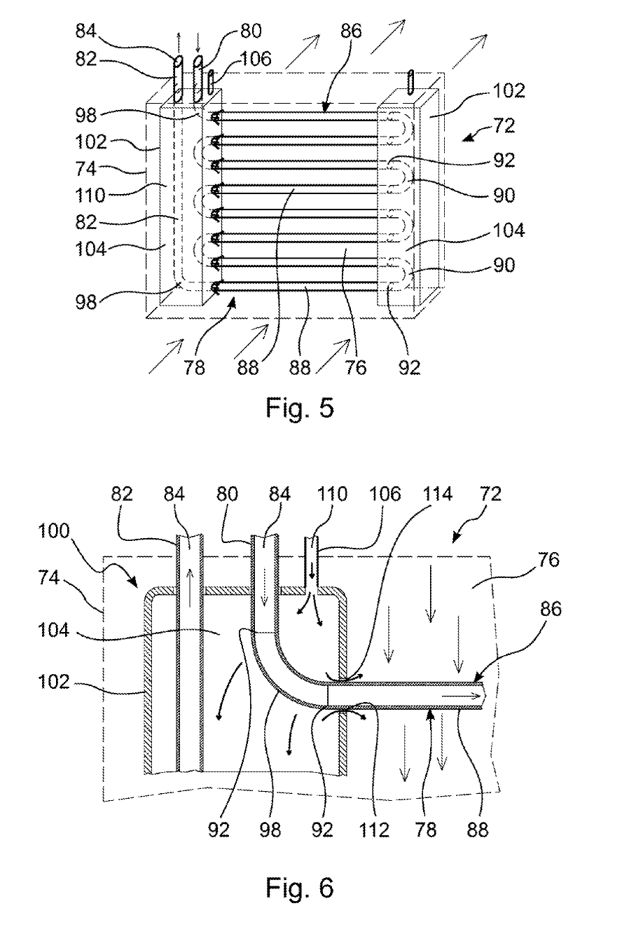

FIG. 5 is a perspective view of a modified heat exchanger;

FIG. 6 is a detail view of a portion of the heat exchanger of FIG. 5;

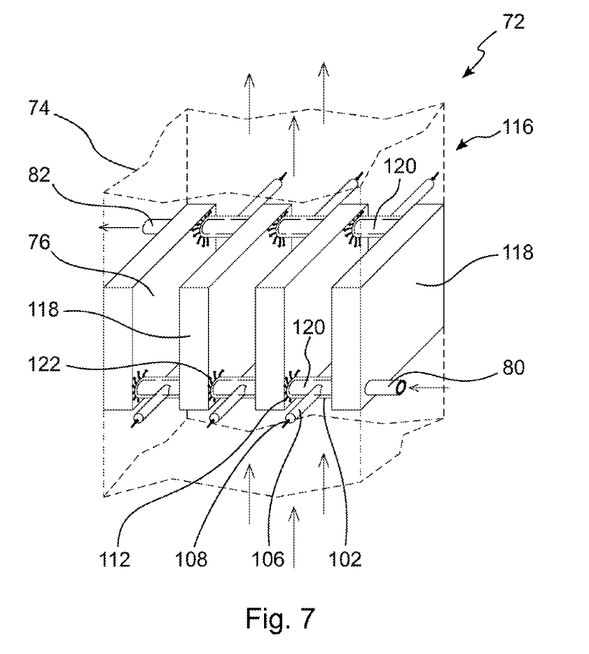

FIG. 7 is a detail view of a plate heat exchanger with a heat exchanger protection system;

FIG. 8 shows a longitudinal section through the conditioning apparatus according to FIG. 1 with a flow layout of the heat exchanger protection system according to a first exemplary embodiment;

FIG. 9 shows a longitudinal section through the conditioning apparatus according to FIG. 1 with a flow layout of the heat exchanger protection system according to a second exemplary embodiment;

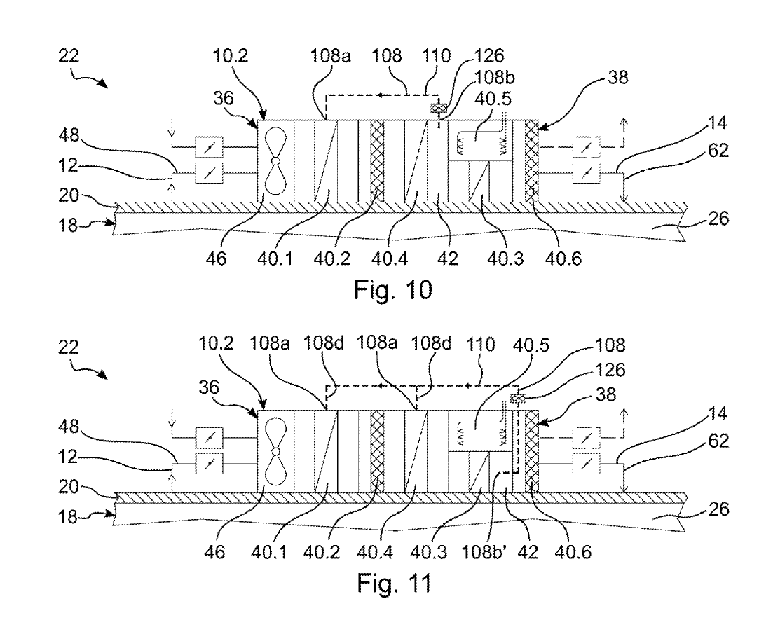

FIG. 10 shows a longitudinal section through the conditioning apparatus according to FIG. 2 with a flow layout of the heat exchanger protection system according to a third exemplary embodiment;

FIG. 11 shows a longitudinal section through the conditioning apparatus according to FIG. 2 with a flow layout of the heat exchanger protection system according to a fourth exemplary embodiment;

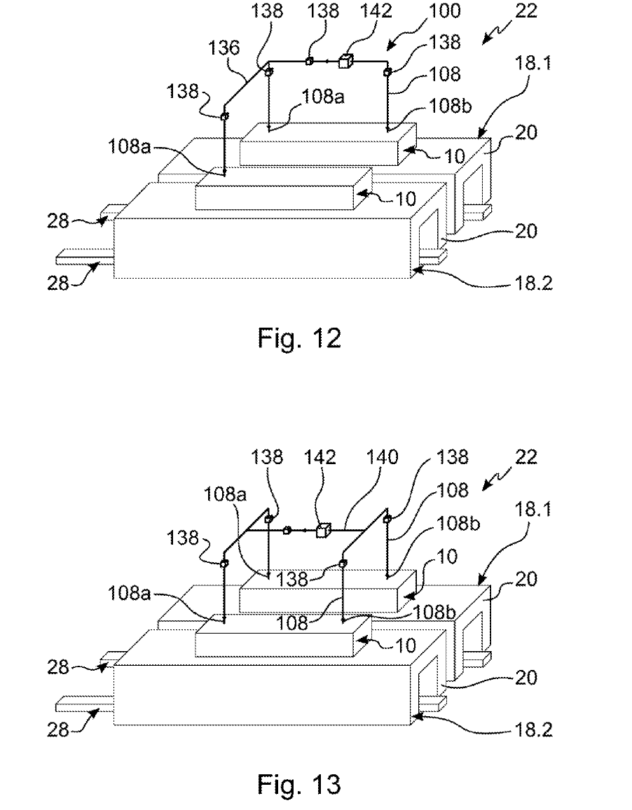

FIG. 12 shows a design of an installation for treating vehicle bodies which has two treatment tunnels arranged in parallel and each having a conditioning apparatus, these being connected together;

FIG. 13 shows a modified design of an installation for treating vehicle bodies which has two treatment tunnels arranged in parallel and each having a conditioning apparatus, these being connected together.

Reference will be made first of all to FIGS. 1 and 2, which show two different designs of conditioning apparatus 10.1 and 10.2 for conditioning a gaseous medium 12 to yield a conditioned gaseous process medium 14. Hereinafter, general reference will be made to a conditioning apparatus 10.

Such a gaseous medium 12 may for example contain an exhaust gas arising during a working process. In the exemplary embodiments described below, the gaseous medium 12 is by way of example at least in part exhaust air 16 which arises in a treatment means 18 with a treatment booth 20 of an installation, denoted overall 22, for treating workpieces 24.

Vehicle bodies are shown as examples of workpieces 24. The workpieces 24 may however also be other workpieces and in particular add-on or mounting parts of vehicle bodies such as bumpers, side mirrors or the like. Smaller workpieces 24 may optionally be arranged on a workpiece holder, which is not in itself shown.

The treatment booth 20 of the treatment means 18 defines a workspace in the form of a treatment tunnel 26 having a tunnel entry 26a and a tunnel exit 26b, through which the workpieces 24 to be treated are conveyed by means of a conveying system 28, as known per se and which need not be addressed in any more detail.

The treatment tunnel 26 has an air outlet 30 and an air inlet 32, between which the conditioning apparatus 10 is arranged, such that exhaust air 16 may be drawn out of the treatment tunnel 26, passed through the conditioning apparatus 10 and, once conditioning is complete, recycled to the treatment tunnel 26 as process air 34. The recycled process air 34 is guided to the workpieces 24 to be treated in a manner known per se via nozzles which are not in themselves illustrated.

This makes it possible to maintain the temperature and treatment conditions needed for effective treatment in the treatment tunnel 26. In a modification which is not in itself shown, the treatment tunnel 26 may also be subdivided into a plurality of tunnel sections, which each have a separate air outlet and air inlet which are connected to the conditioning apparatus 10. Optionally, each tunnel section present may also be associated with its own conditioning apparatus 10, such that different temperatures and treatment conditions may be established in each tunnel section, as is in each case most favorable for the treatment procedure.

The conditioning apparatus 10 comprises an inlet connection unit 36 and an outlet connection unit 38, between which a flow path is formed for gaseous medium 12 having a plurality of conditioning stages 40, and multiple flow chambers 42 arranged between the conditioning stages 40. In the exemplary embodiments according to FIGS. 1 and 2, six conditioning stages 40 are present, by way of example, which comprise a preheating device 40.1, a first filter device 40.2, a cooling device 40.3, a reheating device 40.4, a humidifier 40.5 and a second filter device 40.6.

The conditioning apparatus 10 comprises a feed line 48 for gaseous medium 12 to be conditioned, which line leads into the inlet connection unit 36 and is connected on the inlet side with the air outlet 30 of the treatment means 18. A valve 50 is arranged in the feed line 48, such that the volumetric flow rate of the exhaust air 16 to the inlet connection unit 36 may be adjusted.

In the inlet connection unit 36, the exhaust air 16 firstly flows into an inlet chamber 52. The inlet connection unit 36 of the conditioning apparatus 10 is moreover connected with a fresh air line 54, via which fresh air 56 may be guided from a fresh air source 58 into the inlet chamber 52. A valve 56 is arranged in the fresh air line 54, such that the volumetric flow rate of the fresh air 56 to the inlet connection unit 36 may also be adjusted. The conditioning procedure for the gaseous medium 12, i.e. here the exhaust air 16 from the treatment tunnel 26, consequently also includes admixing with the gaseous medium 12 a proportion of an admix gas, in the present case thus a proportion of fresh air 56. As a consequence, a mixture of the gaseous medium 12 and fresh air 56 constantly flows through the conditioning apparatus 10; for the sake of simplicity, reference is made hereinafter however merely to the gaseous medium 12.

From the outlet connection unit 38 of the conditioning apparatus 10, a process medium line 62 with a valve 64 leads to the air inlet 32 of the treatment means 18. Furthermore, a secondary process medium line 66 with a valve 68 leads away from the outlet connection unit 38.

In the conditioning apparatus 10.1 shown in FIG. 1, the conditioning stages 40 downstream of the inlet chamber 52 are arranged in the following sequence in the direction of flow: preheating device 40.1, first filter device 40.2, cooling device 40.3, reheating device 40.4, humidifier 40.5 and second filter device 40.6; the blower 46 is located between the humidifier 40.5 and the second filter device 40.6. In general terms, the blower 46 is here arranged on the outlet side of the conditioning apparatus 10; in a modification that is not in itself shown, it may also be arranged downstream of the last conditioning stage 40, i.e. here downstream of the second filter device 40.6. All the conditioning stages are here arranged in series, such that the entire gaseous medium 12 flows through them in succession.

In the conditioning apparatus 10.2 shown in FIG. 2, the blower 46 is arranged in the inlet chamber 52. In general terms, the blower 46 is here arranged on the inlet side of the conditioning apparatus 10; in a modification not in itself shown it may also be arranged upstream of the inlet chamber 52. Then, the preheating device 40.1, the first filter device 40.2 and the reheating device 40.4 follow in series, such that the gaseous medium 12 flows as a whole through these conditioning stages 40. The cooling device 40.3 and the humidifier 40.5 are arranged downstream of the reheating device in the direction of flow, but here in parallel, such that the stream of gaseous medium 12 is subdivided downstream of the reheating device 40.4 and one sub-stream 70.1 of the gaseous medium 12 flows through the cooling device 40.3 and one sub-stream 70.2 of the gaseous medium 12 flows through the humidifier 40.5. Thereafter, the sub-streams 70.1, 70.2 are recombined in a mixing flow chamber 42a and the gaseous medium 12 flows through the second filter device 40.6 to the outlet connection unit 38 of the conditioning apparatus 10.2. A flow chamber 42 is in each case provided up- and downstream of the reheating device 40.4 in the sub-stream 70.2.

The preheating device 40.1, the cooling device 40.3 and the reheating device 40.4 serve to adjust the temperature of the gaseous medium 12 and are designed as heat exchangers 72, as illustrated by way of example in FIGS. 3 and 4.

The heat exchanger 72 comprises a heat exchange chamber 76 defined by a housing 74, which chamber accommodates a heat exchange element in the form of a heat exchange coil denoted overall 78.

The heat exchange coil 78 comprises an inflow tube 80 and an outflow tube 82, apparent only in FIG. 4, for a heat exchange medium 84, which may be gaseous or liquid. The inflow tube 80 and the outflow tube 82 are connected together by a plurality of heat exchanger tubes 86, which are arranged spaced from one another. In general, a heat exchange element is a component of a heat exchanger through which heat exchange medium 84 may flow.

The heat exchanger tubes 86 take a serpentine course and to this end comprise tube sections 88 extending parallel to one another in a common plane, adjacent pairs of which are connected together in each case at alternate ends by a connecting tube in the form of a U-tube 90. In the present exemplary embodiment, each heat exchanger tube 86 comprises four parallel tube sections 88 and three U-tubes 90. The heat exchange medium 84 is supplied to the inflow tube 80 and flows from there through the heat exchanger tubes 86 into the outflow tube 82, via which the heat exchange medium 84 is then carried away and subjected to its own conditioning procedure.

The inflow tube 80, the outflow tube 82, the tube sections 88 and the U-tubes 90 are generally made of copper and connected together in a fluid-tight manner in a manner known per se at the respective tube connection points, just a few of which are denoted 92. The tubes may for example be soldered or brazed together, wherein solders or brazing metals known per se are accordingly likewise used. The tube connection points 92 may optionally also be formed by welding, for example if the tubes of the heat exchanger 72 are made from special steel.

The housing 74 has an inlet 94 and an outlet 96 for the gaseous medium 12, which are only shown in FIG. 4, such that the gaseous medium 12 requiring temperature adjustment may flow through the heat exchange chamber 76 and in the process over the heat exchanger tubes 86, such that the desired heat exchange with the gaseous medium 12 may proceed in conventional manner.

FIG. 5 shows a modified heat exchanger 72 in which the inflow tube 80 and the outflow tube 82 are connected together not via multiple, but rather in each case via one connecting tube in the form of a 90° elbow 98 at tube connection points 92 via a single heat exchanger tube 86, which forms a relatively large number of parallel tube sections 88 defined as the heat exchanger tubes 86 of the heat exchanger 72 according to FIGS. 3 and 4. The direction of flow of the gaseous medium 12 perpendicular to the plane defined by the tube sections 88 is shown in FIG. 5 by a plurality of arrows.

As explained above, the tube connection points 92 in particular define regions of material in heat exchange coils 78 which are sensitive and may be damaged by the gaseous medium 12. The exhaust air 16 from the treatment tunnel 26, which flows through the conditioning apparatus 10, entrains aggressive constituents which attack the tube connection points 92 of the heat exchange coil 78 and endanger the tightness of the system.

To reduce and ideally to eliminate this harmful effect, a heat exchanger protection system 100 is provided. This comprises one or more protective housings 102, which each define a protective chamber 104 and which surround one or more such sensitive regions, i.e. in the present exemplary embodiment one or more of the tube connection points 92. Each protective housing 102 has a protective gas inlet 106. The protective gas inlet 106 is connected with an outlet connection 108a of a protective gas line 108, which is not shown in all the figures and via which a protective gas 110 may be supplied to the protective chamber 104. At the end thereof remote from the protective gas inlet 106, the protective gas line 108 has an inlet connection 108b. If multiple protective housings 102 are present, as is the case in FIG. 3, each protective housing 102 may be connected with a separate protective gas line 108 or the protective gas line 108 may be branched into a number of distribution arms 108c, each of which leads to a protective housing 102; the latter is shown in FIG. 3 through the example of two protective housings 102 and two distribution arms 108c of the protective gas line 108.

As an overarching concept, sensitive regions of the heat exchanger 72 may be exposed to the protective gas 110 by means of the heat exchanger protection system 100.

As a result of this measure, it is possible to prevent the sensitive regions from coming into contact with other media.

The protective housing 102 comprises a plurality of passage openings 112, through which the tube sections 88 of the heat exchange coil 78 extend, such that the connecting tubes thereof, i.e. in this case the U-tubes 90 and/or the 90° elbow 98 and above all the tube connection points 92, are arranged inside the protective housing. FIG. 6 illustrates this concept through the example of the heat exchanger 72 according to FIG. 5.

These passage openings 112 are not sealed relative to the tube sections 88 or connected rigidly therewith, so making allowances for thermal expansion of the components, which might otherwise lead to material stresses. Instead, an annular gap 114 remains between the passage openings 112 and the tube sections 88, through which gap, after flowing through the protective housing 102, the protective gas 110 may flow into the heat exchange chamber 76 of the heat exchanger 72, where it mixes with the gaseous medium 12 flowing therein. The passage openings 112 of the protective housing 102 or the annular gap 114 in this way form protective gas outlets for the protective housing 102. If a sealed joint or at least largely sealed joint is possible between the protective housing 102 and the tube sections 88, the protective housing 102 has one or more separate protective gas outlets. Alternatively, a static pressure may be maintained in the protective housing 102 even without further outlets.

FIG. 7 again shows a modified heat exchanger 72, which is designed as a plate heat exchanger 116 and comprises as heat exchange elements a plurality of heat exchanger plates 118 through which heat exchange medium 84 may flow and which are connected fluidically together via connecting tubes 120 and on the inlet side with the inflow tube 80 and on the outlet side with the outflow tube 82. Each connecting tube 120 has a connection point 92 at each end. In this case a protective housing 102 with a protective gas inlet 106 is present for each connecting tube 120, wherein in addition to each connecting point 92 a passage opening 112 of the protective housing 102 is present through which a respective connecting tube 120 exits from the associated protective housing 102 at both ends of the protective housing 102. In this embodiment, an annular gap 122 remains between a heat exchanger plate 118, the connecting tube 120 joined thereto and the protective housing 102, through which gap protective gas 110 may flow out of the protective housing 102 and into the heat exchange chamber 76.

Overall, the protective gas 110 acts as a barrier gas, in the case of air therefore as barrier air, relative to the gaseous medium 12 in the heat exchange chamber 76. Conditioned process medium 14 or partly conditioned gas from the conditioning apparatus 10 serves as the protective gas 110 for the heat exchanger protection system 100. Partly conditioned gas is gas which is removed from the conditioning apparatus 10 before it flows into the process medium line 62, wherein this gas is conditioned such that it can no longer damage sensitive regions of the heat exchanger 72 or at least to a lesser degree than the gaseous medium 12.

FIGS. 8 to 10 show various exemplary embodiments of a flow layout of the heat exchanger protection system 100, wherein in FIGS. 8 to 10 only the basic components and parts have reference signs.

In the exemplary embodiment according to FIG. 8 with the conditioning apparatus 10.1, the inlet connection 108b of the protective gas line 108 is connected downstream of the blower 46 with the conditioning apparatus 10.1, such that protective gas 110 is conveyed into the protective gas line 108 by means of the blower 46. Specifically, the protective gas line 108 is connected to the flow chamber 42 between the blower 46 and the second filter device 40.6.

In a modification not in itself shown, the protective gas line 108 may also be connected downstream of the final conditioning stage 40, for example to the outlet connection unit 38 or to the process medium line 62. In this case, conditioned gas, i.e. here the conditioned, gaseous process medium 14, serves as protective gas 110.

As illustrated in FIG. 3, an adjusting valve 124 may be arranged in the protective gas line 108, such that the proportion of the gas flowing through the conditioning apparatus 10.1 which is removed as protective gas 110 may be adjusted.

The protective gas line 110 leads to the preheating device 40.1, where it is connected with the protective housings 102 provided therein of the heat exchanger protection system 100; this is not visible in FIG. 8. In general terms, the protective gas line 108 is connected with the heat exchanger 72 of the inlet-side conditioning stage 40, irrespective of whether cooling or heating is taking place at that point. The gaseous medium 12 to be conditioned has its most highly aggressive and corrosive action at the inlet of the conditioning apparatus 10, since at that point the gaseous medium 12 has not undergone any treatment of any sort, apart from any addition of fresh gas. If the aggressive and corrosive action of the gaseous medium 12 has accordingly been eliminated once it has flowed through the first filter device 40.2, in subsequent conditioning stages 40 the heat exchangers 72 do not have to be integrated into the heat exchanger protection system 100; protective housings 102 are then accordingly not provided there.

However, one or more further conditioning stages 40, in which a heat exchanger 72 is present, may also be integrated into the heat exchanger protection system 100, and the protective housings 102 may in this case be connected with the protective gas line 108, to which end these are then branched into a corresponding number of side arms which then in turn optionally fork again as required into distribution arms 108c. In a modification, a separate protective gas line 108 may also lead to each conditioning stage 40 in question.

To clarify this, in the exemplary embodiment according to figure all the conditioning stages 40 present in the conditioning apparatus 10.1 which have heat exchangers 72 are integrated into the heat exchanger protection system 100. In this case, these are therefore the preheating device 40.1, the cooling device 40.3 and the reheating device 40.4. The side arms just discussed above of the protective gas line 108 are denoted 108d.

Unlike in the exemplary embodiment according to FIG. 8, the inlet connection 108b of the protective gas line 108 is connected with the conditioning apparatus 10 upstream of the blower 46. Specifically, the protective gas line 108 is there connected with the flow chamber 42 between the reheating device 40.4 and the humidifier 40.5. In addition, a separate protective gas blower 126 is also arranged in the protective line 108, so that protective gas 110 may be drawn off from the conditioning apparatus 10.2 and conveyed to the connected conditioning stages 40. The protective gas blower 126 is also shown in FIG. 3.

In the exemplary embodiment according to FIG. 10 with the conditioning apparatus 10.2, the protective gas line 108 extends between the flow chamber 42, which is arranged upstream adjacent the reheating device 40.4 and humidifier 40.5, and the first conditioning stage 40 in the direction of flow, in this case the preheating device 40.1.

The exemplary embodiment according to FIG. 11 shows a variant of the conditioning apparatus 10.2 in which the inlet connection 108b of the protective gas line 108 is connected with the flow chamber 42, which is placed in this case between the reheating device 40.4 and the mixing flow chamber 42a. The protective gas line 108 leads from there via side arms 108d to the first two conditioning stages 40, which comprise a heat exchanger 72; these are in this case the preheating device 40.1 and the cooling device 40.3.

The statements made above in relation to the conditioning apparatus 10.1 apply mutatis mutandis to possible modifications.

FIG. 3 additionally depicts a control device 128 of the heat exchanger protection system 100. This comprises a control unit 130, by which the adjusting valve 124 and/or the protective gas blower 126 may be controlled, if these are present. Furthermore, the control device 128 comprises sensors 132, with which predetermined properties of the protective gas 110 may be detected. In practice, these are humidity sensors. FIG. 3 shows data and control lines dash-dotted and without their own reference signs.

FIGS. 12 and 13 show a modified installation 22, which comprise two treatment means 18.1 and 18.2 which may be operated in parallel. Each treatment means 18.1, 18.2 comprises its own conditioning apparatus 10.

In the exemplary embodiment according to FIG. 12, a secondary line 136 branches off from the protective gas line 108 of the conditioning apparatus 10 of the treatment means 18.1 downstream of the protective gas blower 126, which secondary line leads to the conditioning apparatus 10 of the treatment means 18.2 and is there connected to the protective housing 102 for one of the heat exchangers 72 of one of the conditioning stages 40 present. In the protective line 108, a further adjusting valve 138 may be provided upstream of the branch point, likewise in the secondary line 136.

In a modification, the protective gas line 108 of the conditioning apparatus 10 of the treatment means 18.1 may also branch into a plurality of such secondary lines 136, to which the conditioning apparatus 10 of the treatment means 18.2 is connected.

In the exemplary embodiment according to FIG. 13, the protective gas lines 108 of the two conditioning apparatuses 10 of the treatment means 18.1 and 18.2 have a common line portion 140, so establishing a type of crossover arrangement of protective gas lines 108. The protective gas blower 126 is arranged in this common line portion 140. In this way, the protective gas 110 from the two conditioning apparatuses 10 may be distributed to the respective heat exchangers 72 or the protective housings 102 present there.

Otherwise, the statements made in relation to the other exemplary embodiments with regard to possible modifications of the line arrangements accordingly also apply mutatis mutandis to the variants according to FIGS. 12 and 13.

As is apparent from FIGS. 12 and 13, a protective gas conditioning unit 142 may moreover also be provided in the protective gas line 108, with which protective gas conditioning unit the protective gas 110 may optionally be additionally conditioned for its intended purpose. This also applies to all the other exemplary embodiments.

For example, the protective gas conditioning unit 142 may be designed as a dehumidifier, if the protective gas 110 of the conditioning apparatus 10 is only removed downstream of the humidifier 40.5. An excessively humid protective gas 110 could put unnecessary strain on the tube connection points 92. However, heating or cooling units or indeed combinations with differently acting units may also be provided.

What is claimed is:

1. A conditioning apparatus for conditioning a gaseous medium to yield a conditioned gaseous process medium comprising:
a) an inlet connection unit and an outlet connection unit, between which is formed a flow path for gaseous medium having one or more conditioning stages, at least one of which comprises a heat exchanger;
b) the heat exchanger has a heat exchange chamber, in which a heat exchange element is accommodated at least in part and to which gaseous medium to be conditioned may be supplied, the heat exchanger comprising regions of sensitive material which may be damaged by the gaseous medium, characterized in that wherein
c) a heat exchanger protection system is provided by means of which such sensitive regions of the heat exchanger may be exposed to a protective gas.

2. The conditioning apparatus as claimed in claim 1, wherein the heat exchanger protection system comprises at least one protective housing, which surrounds one or more sensitive regions of the heat exchanger and to which protective gas may be supplied via a protective gas line.

3. The conditioning apparatus as claimed in claim 2, wherein the protective gas line is connected to the flow path or downstream of a final conditioning stage of the one or more conditioning stages in such a way that partly conditioned gas or process medium and serving as protective gas may be conveyed into the protective housing.

4. The conditioning apparatus as claimed in claim 2, wherein the protective housing comprises at least one protective gas outlet through which protective gas may flow after flowing through the protective housing into the heat exchange chamber.

5. The conditioning apparatus as claimed in claim 2, wherein a protective gas blower and/or an adjusting valve is arranged in the protective gas line.

6. The conditioning apparatus as claimed in claim 1, wherein the sensitive regions of the heat exchanger are formed by tube connection points at which tubes or tube sections of the heat exchanger are joined fluid-tightly together.

7. The conditioning apparatus as claimed in claim 6, wherein the tube connection points, the tubes or the tube sections of the heat exchanger are welded together or soldered or brazed together or adhesively bonded together.

8. The conditioning apparatus as claimed in claim 1, wherein a plurality of conditioning stages are present which comprise a heat exchanger and which are integrated into the heat exchanger protection system.

9. A method for conditioning a gaseous medium comprising the step of using a conditioning apparatus as claimed in claim 1.

10. An installation for treating workpieces comprising a conditioning apparatus as claimed in claim 1.

11. A method for treating workpieces comprising the step of treating the workpieces are treated in an installation as claimed in claim 10.
